(19) United States
(12) Patent Application Publication
(10) Pub. No.: US 2007/0091132 A1
(43) Pub. Date: Apr. 26, 2007

(54) Apparatus to automatically adjust nozzles used, image forming apparatus having the same, and method of automatically adjusting nozzles used

(76) Inventor: Su-min Lim, Seongnam-si (KR)

Correspondence Address: STANZIONE & KIM, LLP, 919 18TH STREET, N.W., SUITE 440, WASHINGTON, DC, 20006, US

(21) Appl. No.: 11/430,119

(22) Filed: May 9, 2006

(30) Foreign Application Priority Data
Oct. 24, 2005 (KR) 2005-0100358

(51) Int. Cl. B41J 29/38

(52) U.S. Cl. 347/14

(57) ABSTRACT

An apparatus to automatically adjust nozzles used includes a sensing part disposed at an inlet side of a print head having a plurality of unit nozzles and to sense an area around at least one edge of a printing medium, and a nozzle use adjustment part to adjust unit nozzles to be used for printing from among the plurality of unit nozzles in the print head according to a position of the at least one edge of the printing medium detected from a data of the area around the at least one edge sensed by the sensing part. Therefore, the unit nozzles of the print head to be used for printing are automatically adjusted within a certain range by using the sensing part and the nozzle use adjustment part so that image information can be accurately printed on a printing area of the printing medium although the printing medium may not be accurately set on a reference position by a medium adjustment guide of a paper feeding cassette or is shifted from the reference position by a pick up roller when picked up or fed. Accordingly, image quality can be improved and consumption of ink and printing medium based on additional printing can be decreased.

### CROSS-REFERENCE TO RELATED APPLICATIONS

This application claims the benefit under 35 U.S.C. § 119 (a) of Korean Patent Application No. 2005-100358, filed on Oct. 24, 2005, the entire content of which is incorporated herein by reference.

### BACKGROUND OF THE INVENTION

1. Field of the Invention

The present general inventive concept relates to an image forming apparatus having a print head such as an inkjet printer, a multifunctional device, and a facsimile machine. More particularly, the present general inventive concept relates to an image forming apparatus having an array type print head having a width that corresponds to a size of a print medium, such as a paper, so that image information can be printed by a plurality of line units (line by line).

2. Description of the Related Art

Since the demand for high resolution printing quality and high speed printing has recently increased efforts have been made to develop an image forming apparatus such as an inkjet printer, a multifunctional device, and a facsimile machine having an array type print head in which a plurality of heater chips and unit nozzles are aligned along a width that corresponds to a size of a print medium so that image information can be consecutively printed in accordance with a plurality of line units (i.e., line by line).

Since the image forming apparatus having the array type print head can consecutively print the image information by the plurality of line units, a printing speed thereof is faster than that of the image forming apparatus having a carrier type print head (i.e., shuttle type), which mounts the print head to a carrier and moves the carrier to the left and the right to print the image forming information. Additionally, the print head in the array type print head may be fixed or stopped and the print medium moves for printing so that the image forming apparatus having the array type print head does not need a carrying device such as the carrier used in the image forming apparatus having the carrier type print head. Accordingly, the image forming apparatus having the array type print head may be preferred to the image forming apparatus having the carrier type print head in order to improve the printing speed and simplify the structure thereof.

FIG. 1 is a schematic view illustrating an image forming apparatus 1 having a conventional array type print head 10.

Referring to FIG. 1, the image forming apparatus 1 includes a feeding roller 12 and the conventional array type print head 10. The feeding roller 12 conveys a printing medium P′ to a printing zone on a base frame 13, and the array type print head 10 is fixed to eject ink onto the printing medium P′ fed to the printing zone by the feeding roller 12 to form an image.

FIG. 2 is a bottom view of the conventional array type print head 10 of the image forming apparatus 1 of FIG. 1. As illustrated in FIG. 2, the array type print head 10 includes a plurality of unit nozzles 11 that are arranged in a plurality of lines and rows at regular intervals and exposed outside the image forming apparatus 1.

A plurality of heater chips (not shown) are provided in a plurality of ink chambers (not shown), each of which is aligned in the array type print head 10 to correspond to each unit nozzle 11.

Each ink chamber receives ink via an ink supply pipe (not shown) connected to an external ink storage (not shown).

Each heater chip instantly heats the ink provided in the corresponding ink chamber and generates and expands ink bubbles. The generated ink bubbles are sprayed onto the printing medium P′ via the unit nozzle 11 by expanded pressure.

However, since the image forming apparatus 1 has a structure in which the array type print head 10 stops and ejects the ink onto the moving printing medium P′, the image information printed on the printing medium P′ is deviated from the printing area of the printing medium P′ by as much as a distance by which the printing medium P′ is displaced or shifted from a reference position. This displacement shift occurs from the reference position (1) if the printing medium P′ is not accurately set on the reference position by a medium adjustment guide (not shown) when loaded in a paper feeding cassette (not shown), or (2) if the printing medium P′ is shifted from the reference position set on the paper feeding cassette by a pick up roller (not shown) or the feeding roller 12 when picked up or fed. As a result, an image quality decreases, and a user may even be required to re-print, causing ink and printing medium P′ to be unnecessarily consumed.

Additionally, if the printing medium P′ is displaced or shifted, under a general printing mode having a margin in the printing medium P′, a printing inferiority occurs in which the image information is not printed to (i.e., deviates from) the printing area of the printing medium P′. However, under a borderless printing mode having no margin in the printing medium P′, another problem occurs besides the image inferiority. In particular, the ink is further ejected to the base frame 13 by as much as the deviation distance by which the printing medium P′ is displaced or shifted to one side, for example, left or right printing margin. At this time, the ink ejected on the base frame 13 does not easily dry and may cause the printing medium P′ to wrinkle or curl due to a skew. Additionally, if ink is ejected in a great quantity, a bottom surface of the printing medium P′ may be easily contaminated.

### SUMMARY OF THE INVENTION

Accordingly, the present general inventive concept provides an apparatus to automatically adjust nozzles used in a print head to accurately print image information onto a printing area of a printing medium even when the printing medium is not accurately set on a reference position by a medium adjustment guide of a paper feeding cassette or when the printing medium is shifted from the reference position by a pick up roller or a feed roller, an image forming apparatus having the same, and a method of automatically adjusting the nozzles used.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an apparatus to automatically adjust nozzles used in an image forming device having a print head including a plurality of unit nozzles, the apparatus including a sensing part disposed at an inlet side of a print head and to sense an area around at least one edge of a printing medium, and a nozzle use adjustment part to adjust unit nozzles to be used for printing according to a position of the at least one edge of the printing medium detected from a data of the area around the at least one edge sensed by the sensing part.

The sensing part may be disposed perpendicularly to the at least one edge of the printing medium and may include one of at least one contact image sensor and at least one charge coupled device sensor.

The nozzle use adjustment part may include an image process part to extract a portion identical with a fiducial grayscale from the data of the area around the at least one edge sensed by the sensing part to detect a data of the at least one edge of the printing medium, and to calculate a deviation distance by which the at least one edge of the printing medium deviates from a preset reference position from the data of the at least one edge detected thereby, and a microprocessor to determine the unit nozzles to be used for printing from among the plurality of unit nozzles in the print head according to the calculated deviation distance and to control the determined unit nozzles to eject an ink onto a printing area of the printing medium with a certain printing margin.

The print head may include an array type print head in which the plurality of unit nozzles are aligned in a widthwise direction of the printing medium opposite to the printing medium and arranged in a plurality of lines and rows at regular intervals. The at least one edge of the printing medium may be an edge of the printing medium that is parallel with a medium feeding direction, and the certain printing margin may include a printing margin for the edge of the printing medium.

The foregoing and/or other aspects of the present general inventive concept are also achieved by providing a nozzle-use adjustment device usable in an image forming apparatus having a print head with a plurality of nozzles extending along a length that is greater than a width of a printing medium, the device including a sensing unit to sense a lateral position of a predetermined portion of the printing medium with respect to a lateral reference position, and a nozzle adjustment part to select a group of adjacent nozzles to print from among the plurality of nozzles in the print head according to the lateral position of the predetermined portion of the printing medium with respect to the reference position.

The foregoing and/or other aspects of the present general inventive concept are also achieved by providing a nozzle-use adjustment device usable in an image forming apparatus having a print head, the device including a sensing part to determine information about a lateral location of a printing medium, and a nozzle adjustment part to select nozzles in the print head that correspond to the information about the lateral location of the printing medium.

The foregoing and/or other aspects of the present general inventive concept are also achieved by providing a nozzle-use adjustment device usable in an image forming apparatus having a print head having a plurality of nozzles extending at least as wide as a printing medium, the device including a sensing part to sense a lateral position of the printing medium in a printing zone, and a nozzle adjustment part to select a first group of the plurality of nozzles to perform a first printing operation when the sensing part senses that the printing medium is in a first lateral position and to select a second group of the plurality of nozzles to perform a second printing operation when the sensing part senses that the printing medium is in a second lateral position.

The foregoing and/or other aspects of the present general inventive concept are also achieved by providing an image forming apparatus including a feeding part to feed a printing medium, an array type print head in which a plurality of unit nozzles are aligned in a widthwise direction of the printing medium opposite to the printing medium and arranged in a plurality of lines and rows at regular intervals, a sensing part disposed at an inlet side of the array type print head to sense an area around at least one edge of the printing medium fed by the feeding part, and a nozzle use adjustment part to adjust unit nozzles to be used for printing according to a position of the at least one edge of the printing medium detected from a data of the area around the edge sensed by the sensing part.

The nozzle use adjustment part may include an image process part to extract a portion identical with a fiducial grayscale from the data of the area around the edge sensed by the sensing part to detect a data of the at least one edge of the printing medium, and to calculate a deviation distance by which the at least one edge of the printing medium deviates from a preset reference position from the data of the at least one edge detected thereby, and a microprocessor to determine the unit nozzles to be used for printing from among the plurality of unit nozzles in the array type print head according to the calculated deviation distance and to control the determined unit nozzles to eject an ink onto a printing area of the printing medium with a certain printing margin.

The at least one edge of the printing medium may be an edge of the printing medium that is parallel with a medium feeding direction, and the certain printing margin may include a printing margin for the edge of the printing medium.

The foregoing and/or other aspects of the present general inventive concept are also achieved by providing an image forming apparatus, including a print head having a plurality of nozzles extending in a line along at least a width of a printing medium, a sensing part to determine information about a location of the printing medium, and a nozzle adjustment part to select nozzles in the line in the print head that correspond to the information about the location of the printing medium.

The foregoing and/or other aspects of the present general inventive concept are also achieved by providing an image forming apparatus, including a print head disposed in a fixed position and including a plurality of nozzles arranged in a line extending at least a width of a printing medium, a frame to receive the printing medium to a printing position for printing, and a nozzle adjustment unit to determine a position of the printing medium and to control the nozzles in the print head to print to the printing medium with a proper margin, regardless of whether the position of the printing medium is the printing position.

The foregoing and/or other aspects of the present general inventive concept are also achieved by providing a method of automatically adjusting nozzles used in an image forming apparatus, the method including detecting a position of at least one edge of a printing medium, determining unit nozzles of a print head to be used for printing according to the detected position of the at least one edge of the printing medium, and controlling the determined unit nozzles to eject an ink onto a printing area of the printing medium.

The detecting of the position of the at least one edge of the printing medium may include sensing an area around the at least one edge of the printing medium, extracting a portion identical with a fiducial grayscale from a data of the sensed area around the at least one edge of the printing medium to detect a data of the at least one edge of the printing medium, and calculating a coordinate value of the at least one edge of the printing medium from the detected data of the at least one edge of the printing medium.

The determining of the unit nozzles of the print head to be used for printing may include comparing the calculated coordinate value of the at least one edge of the printing medium with a preset coordinate value of a reference data to calculate a deviation distance by which the at least one edge of the printing medium deviates from a preset reference position, and determining the unit nozzles to be used for printing as shifting by as much as the calculated deviation distance.

The controlling of the determined unit nozzles to eject the ink may include ejecting the ink onto a printing area of the printing medium having a certain printing margin by using the unit nozzles determined as the unit nozzles to be used for printing.

The foregoing and/or other aspects of the present general inventive concept are also achieved by providing a method of controlling an image forming apparatus including a print head having a plurality of nozzles extending along at least a width of a printing medium, the method including sensing information about a lateral location of the printing medium, and selecting nozzles from among the plurality of nozzles in the print head that correspond to the information about the lateral location of the printing medium.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a partial cross-sectional view illustrating an image forming apparatus having a conventional array type print head;

FIG. 2 is a bottom view illustrating the conventional array type print head of the image forming apparatus of FIG. 1;

FIG. 3 is a schematic cross-sectional view illustrating an inkjet printer including a nozzle-use adjustment unit to automatically adjust nozzles being used for printing according to an embodiment of the present general inventive concept;

FIG. 4 is a block diagram illustrating the nozzle-use adjustment unit of the inkjet printer of FIG. 3;

FIG. 5 is a top plan view illustrating a sensing part of the nozzle use adjustment unit and an array type print head of the inkjet printer of FIG. 3;

FIGS. 6A and 6B are bottom views illustrating operation of the nozzle use adjustment unit of FIG. 4 according to an embodiment of the present general inventive concept;

FIGS. 7A and 7B are top plan views illustrating examples of a printing margin of a printing area under a general printing mode and a borderless printing mode, respectively; and

FIG. 8 is a flowchart illustrating a method of automatically adjusting nozzles being used for printing in an inkjet printer according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

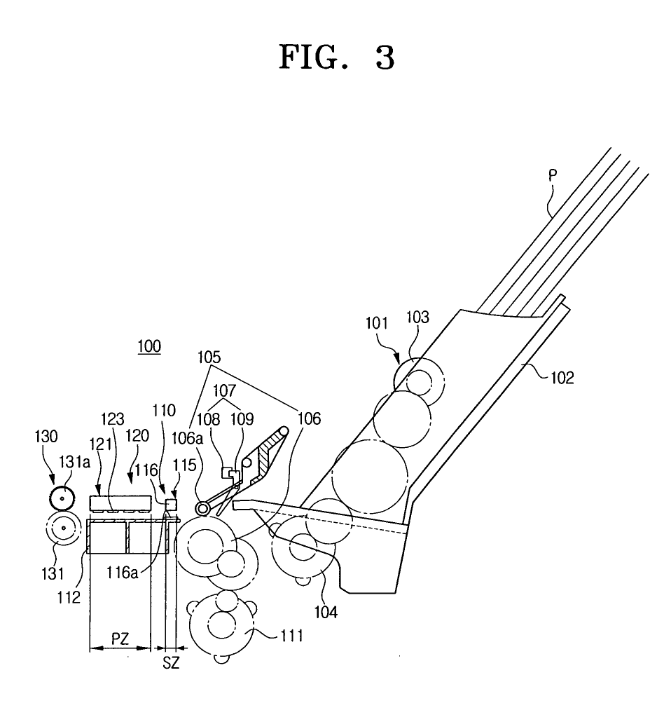

FIG. 3 is a view illustrating an image forming apparatus 100 including an automatic nozzle use adjustment device to adjust nozzles being used according to an embodiment of the present general inventive concept.

The image forming apparatus 100 according to the present embodiment may be an inkjet printer to process image information received from a computer (not shown) and/or a scanner (not shown) to perform a printing operation.

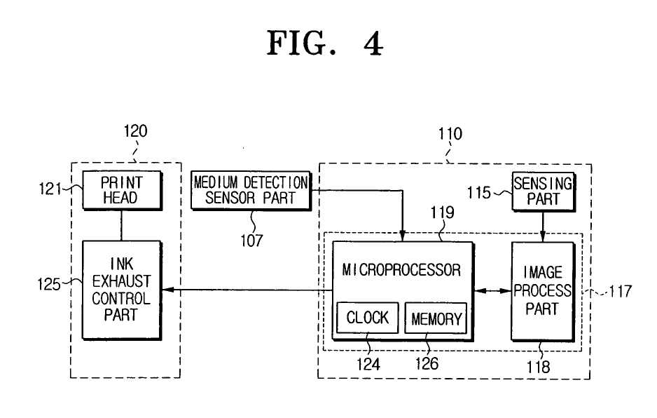

Referring to FIG. 3, the inkjet printer 100 includes a paper feeding unit 101, a feeding unit 105, an automatic nozzle-use adjustment unit 110, a printing unit 120, and a discharge unit 130. FIG. 4 is a block diagram of the nozzle-use adjustment unit 110 of the inkjet printer 100 of FIG. 3.

The paper feeding unit 101 to feed a printing medium P includes a paper feeding tray or a paper feeding cassette 102 and a pick up roller 103.

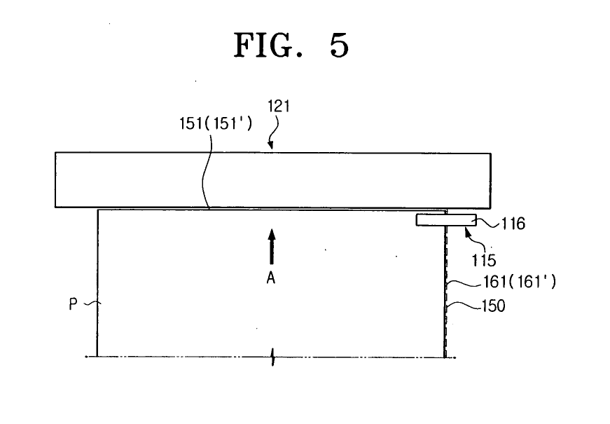

The paper feeding cassette 102 stacks the printing medium P, such as a paper, and has a medium guide surface (not shown) such that one edge of the printing medium P, for example, a right edge 161 or 161′ (see FIGS. 5 through 7B) parallel with a medium feeding direction A, can be located at a reference position 150 by a medium adjustment guide (not shown).

The pick roller 103 picks up and feeds the printing medium P stacked in the paper feeding cassette 102 sheet by sheet in cooperation with a friction buckler (not shown) to provide the printing medium P to the feeding unit 105, sheet by sheet. The pick up roller 103 is driven by a pick up motor 104.

The feeding unit 105 feeds the printing medium P picked up by the pick up roller 103 of the paper feeding unit 101 and includes a feeding roller 106 and a back up roller 106a. The feeding roller 106 feeds the printing medium P picked up by the pick up roller 103 in cooperation with the back up roller 103. The back up roller 106a applies a certain pressure on the printing medium P against the feeding roller 106. The feeding roller 106 is driven by a feeding motor 111.

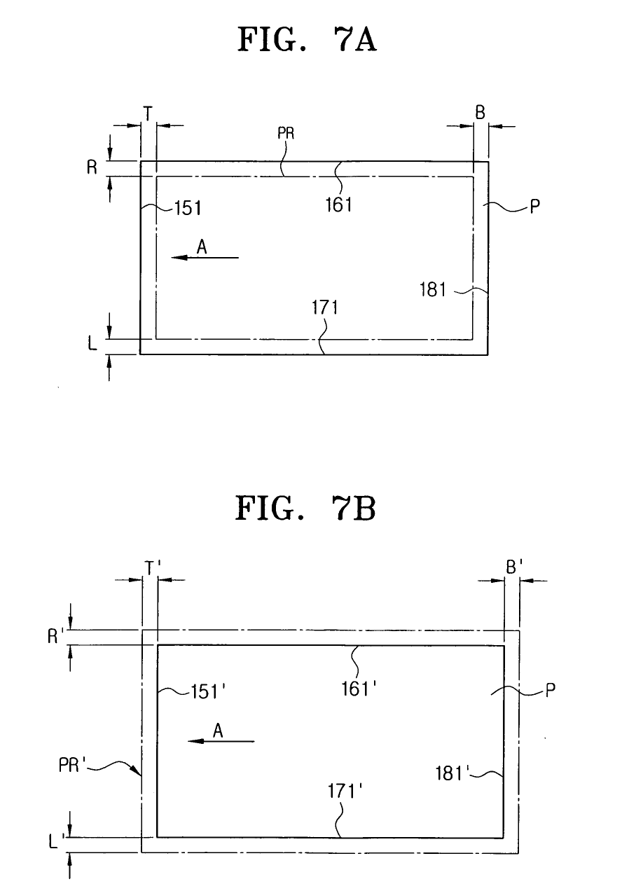

A medium detection sensor part 107 is disposed between the pick up roller 103 and the feeding roller 106. The medium detection sensor part 107 detects a top edge of 151 or 151′ of the printing medium P and a bottom edge 181 or 181′ (see FIGS. 7A and 7B) of the printing medium P, and includes a sensor actuator 109 and a photo sensor 108.

The photo sensor 108 includes a light emission part and a light reception part, and the sensor actuator 109 is pivotably engaged with respect to the photo sensor 108 in a transverse direction to a medium feeding direction A to operate the photo sensor 108.

Referring to FIGS. 3 and 4, the medium detection sensor part 107 detects the top edge 151 or 151′ and the bottom edge 181, or 181′ of the printing medium P fed in the medium feeding direction A to transmit corresponding top and the bottom edge detection signals to a microprocessor 119 of nozzle adjustment part 117 which will be explained later.

When the top edge detection signal is generated, the microprocessor 119 drives the pick up motor 104 and counts through a clock 124 for a preset first time T1 that it takes the top edge 151 or 151′ of the printing medium P to reach a nip between the feeding roller 106 and the back up roller 106a and controls the pick up motor 104 to stop when the first time T1 has passed. Also when the top edge detection signal is generated, the microprocessor 119 counts through the clock 124 for a preset second time T2 that it takes the top edge 151 or 151′ of the printing medium P to completely enter a sensing zone SZ so as to stop the feeding motor 111 when the second time T2 has passed. The microprocessor 119 controls a sensing operation of a sensing part 115 via an image process part 118 according to a method of automatically adjusting nozzles used according to an embodiment of the present general inventive concept. The method will be explained later. Additionally, after the sensing part 115 performs the sensing operation, the microprocessor 119 re-drives the feeding motor 111 and counts through the clock 124 for a preset third time T3 that it takes the top edge 151 or 151′ of the printing medium P to completely enter a printing zone PZ from a time when the feeding motor 111 is driven. Therefore, the microprocessor 119 controls a heater chip of an array type print head 121 of the printing unit 120 by using an ink exhaust control part 125 of the printing unit 120 to perform a printing when the third time T3 has passed. The ink exhaust control part 125 will be explained later.

Referring to FIGS. 3 and 4, the automatic nozzle-use adjustment unit 110 adjusts unit nozzles 123 to be used for printing in the array type print head 121 of the printing unit 120, and includes the sensing part 115 and the nozzle adjustment part 117.

FIG. 5 is a top plan view illustrating the sensing part 115 of the nozzle-use adjustment unit 110 and the array type print head 121 of the inkjet printer 100 of FIG. 3. As illustrated in FIG. 5, the sensing part 115 is disposed at an inlet side of the array type print head 121 with respect to a medium feeding direction A and is disposed along a widthwise direction of the right edge 161 or 161′ so as to sense an area around the right edge 161 or 161′ of the printing medium P fed by the feeding roller 106.

Referring to FIGS. 3 to 5, the sensing part 115 may include a compact contact image sensor (CIS) 116. The CIS 116 emits light onto the printing medium P and senses reflected light through a light reception part to convert an image data of the printing medium P into an electric signal according to a degree of received light depending on the reflection. The sensing part 115 includes a plurality of light emitting diodes (LEDs) and the light reception part senses the light emitted from the plurality of LEDs and reflected from the printing medium P. When the printing medium P is set by the medium adjustment guide of the paper feeding cassette 102 or picked up and fed by the pick up roller 103 and the feeding roller 106, a position of the right edge 161 or 161′ may be changed (i.e. deviated) from the reference position 150. Therefore, the CIS 116 may have a sensing width that covers an entire range along which the right edge 161 or 161′ can be displaced in order to sense the right edge 161 or 161′ even though the position of the right edge 161 or 161′ may change.

The sensing part 115 may further include a white surface 11 6a on the base frame 112 opposite from the CIS 116 such that the image process part 118 does not detect an image data from the base frame 112 which may be confused with the image data of the right edge 161 or 161′ even though the CIS 116 is operated when the printing medium P is not positioned on the sensing zone SZ.

Here, the sensing part 115 is described as being the CIS 116. However, this description is not intended to limit the scope of the present general inventive concept. The sensing part 115 may be a variety of other types of image sensors, such as a charge coupled device (CCD), that can convert the image data sensed from the printing medium P into the electrical signal.

The nozzle adjustment part 117 detects a position of the right edge 161 or 161′ of the printing medium P from the image data of the area around the right edge 161 or 161′ sensed by the CIS 116 and adjusts the unit nozzles 123 to be used for printing according to the detected position. The nozzle adjustment part 117 includes the image process part 118 and the microprocessor 119.

The image process part 118 may be an image process circuit which extracts a portion identical to a preset grayscale that corresponds to the image of the edge of the printing medium P from the image data of the area around the right edge 161 or 161′ sensed by the CIS 116 to detect the image data of the right edge 161 or 161′.

The microprocessor 119 controls overall operation of the inkjet printer 100 and may be a microchip having the image process part 118 in a circuit board (not shown).

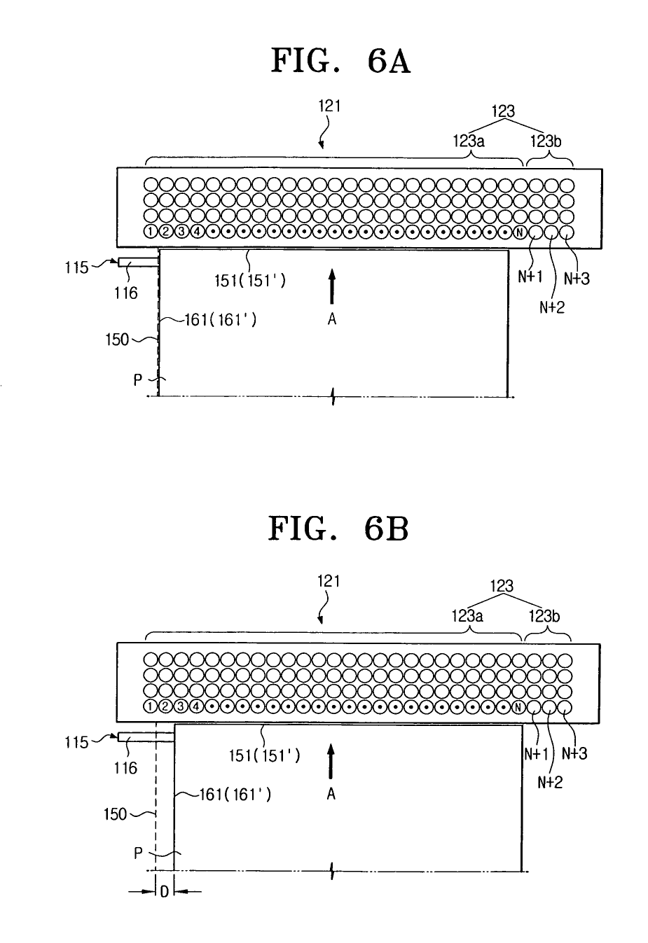

FIGS. 6A and 6B are bottom views illustrating operation of the nozzle-use adjustment unit 110 of FIG. 4 according to an embodiment of the present general inventive concept. The microprocessor 119 compares a coordinate value of the image data of the right edge 161 or 161′ of the printing medium P detected by the image process part 118, such as an average value of X axis coordinate values, with a coordinate value of the reference position 150 stored in a memory 126, such as an X axis coordinate value, so as to calculate a deviation distance D by which the right edge 161 or 161′ of the printing medium P deviates from the reference position 150. The microprocessor 119 determines the unit nozzles 123 to be used for printing according to the calculated deviation distance D. In other words, as illustrated in FIG. 6A, if the calculated deviation distance D is 0, the unit nozzles 123 of a preset first row through nth row are determined (i.e., selected) as the unit nozzles 123 to be used for printing. Additionally, as illustrated in FIG. 6B, if the calculated deviation distance D is equal to a width of one row (e.g., a second row) of the unit nozzles 123, the unit nozzles 123 to be used for printing are shifted from the first row through the nth row to the right in FIG. 6B (to the left in FIG. 5) by one row so that the unit nozzles 123 of the second row through the (n+1)th row are determined as the unit nozzles 123 to be used for printing. Then, the microprocessor 119 controls the ink exhaust control part 125 of the printing unit 120 so that the selected unit nozzles 123 can eject ink onto a printing area PR or PR′ of the printing medium P (see FIGS. 7A and 7B) having certain printing margins T, B, L, R or T′, B′, L′, R′, respectively. In other words, by detecting the deviation distance D from the reference position 150, the nozzle use adjustment unit 110 can select a group of unit nozzles 123 to be used for printing from among all the unit nozzles 123a and 123b in the array type print head 121. That is, the array type print head 121, includes extra nozzles 123b such that the unit nozzles 123 to be used for printing can be shifted among the unit nozzles 123a and 123b according to the deviation distance D. The unit nozzles 123a and 123b extend across the width of the printing medium P of a maximum size printable by the inkjet printer 100 under the borderless printing mode plus a maximum deviation distance of the printing medium P from the reference position 150.

FIGS. 7A and 7B are top plan views illustrating examples of a printing margin of the printing area PR or PR′ under a general printing mode and a borderless printing mode, respectively. As illustrated in FIGS. 7A and 7B, under the general printing mode having margins in the printing medium P, the printing margins T, B, L, R are top, bottom, left and right printing margins T. B, L, R out of the printing area PR. Under the borderless printing mode having no margins in the printing medium P, the printing margins T′, B′, L′, R′ are top, bottom, left and right printing margins T′, B′, L′, R′ outside of the printing medium P. No image information is printed on the printing margins T, B, L, R, whereas the image information is printed on the printing margins T′, B′, L′, R′, which are parts of the printing area PR′. The ink ejected on the printing margins T′ B′, L′, R′ of the printing area PR′ may be stuck on the base frame 112. However, since an amount of ink that is ejected to the base frame 112 is minimized by the nozzle adjustment part 117, the ink on the base frame 112 does not cause any noticeable decrease in image quality, or negatively impact the printing operation.

The printing unit 120 that prints the image information on the printing medium P fed by the feeding roller 106, includes the array type print head 121 and the ink exhaust control part 125.

Referring to FIGS. 3 to 6B, the array type print head 121 includes the plurality of unit nozzles 123 aligned along the widthwise direction of the printing medium P opposite to the printing medium P. The plurality of unit nozzles 123 may be arranged in a plurality of lines and rows at regular intervals.

The plurality of unit nozzles 123 eject ink onto the printing medium P when the ink is instantly heated and expanded by the heater chip (not shown) provided at the ink chamber (not shown) in the array type print head 121.

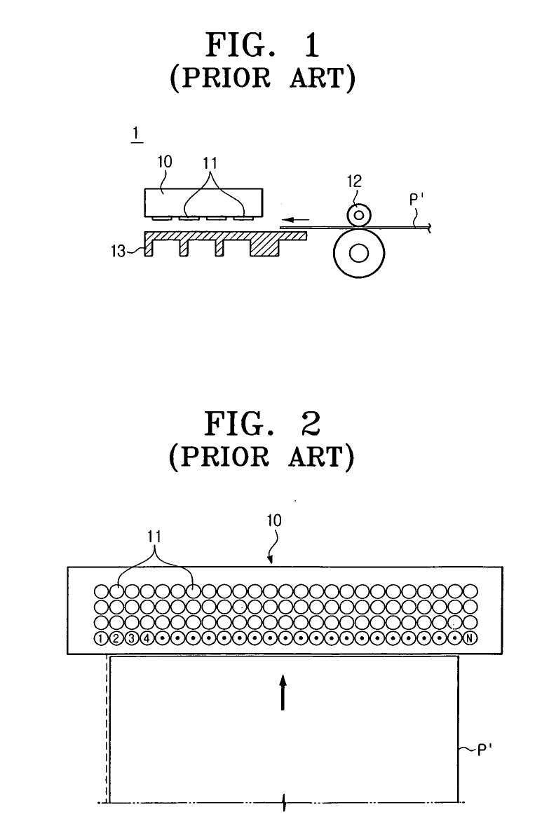

The array type print head 121 may have more unit nozzles 123 than the array type print head 10 of FIG. 1. In other words, as described above, the array type print head 121 of the present embodiment includes the extra unit nozzles 123b (i.e., the unit nozzles 123b of the n+1 row through the n+3 row at one side thereof). For example, as illustrated in FIGS. 6A and 6B, the extra unit nozzles 123b may be disposed on the right side of the array type print head 121, when viewed from the bottom. Other arrangements of the extra nozzles 123b may also be used. The extra nozzles 123b are provided beside the unit nozzles 123a of the first row through the nth row that can print to the printing medium P of a maximum size, printable by the inkjet printer 100, under the borderless printing mode. The extra nozzles 123b are provided in order to give an adjustment space in which the nozzle adjustment part 117 can shift and change the unit nozzles 123 selected to be used for printing to the right or the left of FIG. 6B according to the deviation distance D of the right edge 161 or 161′, when a position of the right edge 161 or 161′ of the printing medium P is displaced from the reference position 150 or is displaced back to the reference position.

The ink exhaust control part 125 controls the heater chip so that the unit nozzles 123 can eject the ink onto the printing area PR or PR′ of the printing medium P by an ink exhaust control signal of the microprocessor 119 according to the image information.

Referring to FIGS. 3 to 7B, the discharge unit 130 discharges the printing medium P, on which the image information is printed by the printing unit 120, outside of the inkjet printer 100 and includes a discharge roller 131 and a star wheel 131a. The discharge roller 131 is driven by the feeding motor 111 via a gear train (not shown).

In the above explanation, the image forming apparatus employing the automatic nozzle-use adjustment unit 110 according to the present embodiment is applied to the inkjet printer 100 having the paper feeding cassette 102 including the paper guide surface to guide the printing medium P to locate the right edge 161 or 161′ at the reference position 150 by the medium adjustment guide. However, this arrangement is not intended to limit the scope of the present general inventive concept.

In other words, the present embodiment may alternatively be applied to an inkjet printer (not shown) having a paper feeding cassette (not shown) to guide the printing medium P to be located at a center thereof by a medium adjustment guide (not shown). At this time, a reference position (not shown) of the printing medium P used when the automatic nozzle-use adjustment unit 110 calculates the deviation distance D of the right edge 161 or 161′ of the printing medium P, is set differently according to a size of the printing medium P printable by the inkjet printer and stored into the memory 126. Accordingly, when calculating the deviation distance D by which the right edge 161 or 161′ of the printing medium P is deviated from the reference position, the microprocessor 119 compares a first coordinate value of the printing medium P (i.e., an average value of X axis coordinate values of the image data of the right edge 161 or 161′ of the printing medium P detected by the image process part 118) with a second coordinate value of the reference position (i.e., X axis coordinate value of the reference position 150 that corresponds to the size of the printing medium P which may be input through a printer control program of a computer or a control panel (not shown) of the inkjet printer) so as to calculate the deviation distance D. The sensing part 115 may be configured to have a sensing width to sense all the right edge 161 or 161′ of the printing medium P, regardless of whether the printing medium P is one of a maximum size and a minimum size that is printable by the inkjet printer. An array type print head (not shown) may further include extra unit nozzles (not shown), such as the extra nozzles 123b illustrated in FIGS. 6A and 6B, at a left side as well as a right side thereof. The extra unit nozzles are further provided beside unit nozzles (not shown), such as the unit nozzles 123a illustrated in FIGS. 6A and 6B, such that the inkjet printer of the present embodiment can use the array type print head to print the printing medium P of the maximum size printable thereby in the borderless printing mode. In other words, the present embodiment allows the inkjet printer to print to a variety of different sizes of printing mediums by adjusting the reference position and/or number of unit nozzles to be used for printing for the different sizes.

In the above explanation, the image forming apparatus employing the automatic nozzle-use adjustment unit 110 is described as the inkjet printer 100. However, this description is not intended to limit the scope of the present general inventive concept. The automatic nozzle-use adjustment unit 110 may be applied to other types of image forming apparatuses such as a multifunctional device, a facsimile machine, etc.

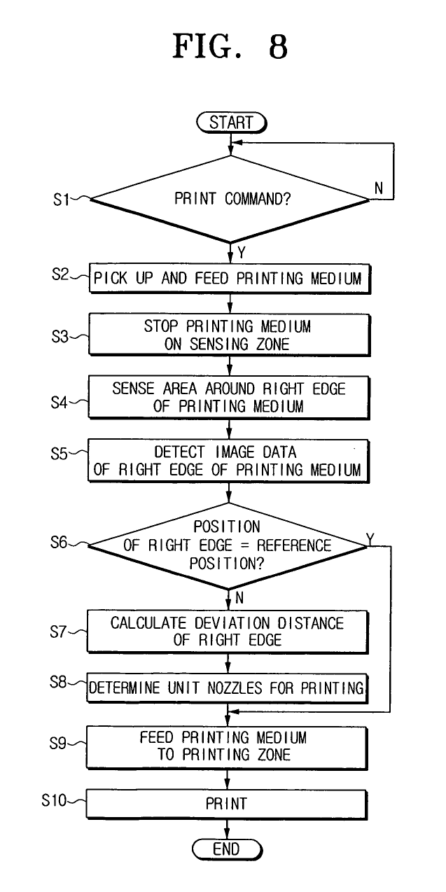

FIG. 8 illustrates a method of automatically adjusting nozzle-use of an inkjet printer. The method of FIG. 8 may be performed in the inkjet printer 100 of FIG. 3 by the automatic nozzle-use adjustment unit 110 of FIGS. 3 and 4. Accordingly, for illustration purposes, the method of FIG. 8 will be explained with reference to FIGS. 3 through 8.

When a print command is given (operation S1), a power is applied to the pick up motor 104 by a control of the microprocessor 119 and accordingly, gears connected to the pick up motor 104 are rotated so as to rotate the pick up roller 103.

In cooperation with the friction buckler, the pick up roller 103 picks up one sheet of the printing medium P stacked on the paper feeding cassette 102 to feed to the feeding roller 106.

When the sensor actuator 109 of the medium detection sensor part 107 is moved by the top edge 151 or 151′ of the printing medium P and the photo sensor 108 generates an ON signal (i.e., the top edge detection signal, the microprocessor 119 applies power to the feeding motor 111. As a result, the feeding roller 106 and the discharge roller 131 are rotated in a direction of feeding the printing medium R

The microprocessor 119 counts time from a time in which the photo sensor 108 generates the top edge detection signal, and cuts the power applied to the pick up motor 104 when the preset first time T1 that it takes the top edge 151 or 151′ of the printing medium P to arrive at the nip between the feeding roller 106 and the back up roller 106a elapses.

The top edge 151 or 151′ of the printing medium P held in the nip between the feeding roller 106 and the back up roller 106a is fed to the sensing zone SZ on the base frame 112 by the feeding roller 106 driven by the feeding motor 111 (operation S2).

When the preset second time T2 that it takes the top edge 151 or 151′ of the printing medium P to completely enter the sensing zone of the base frame 112 from the time when the photo sensor 108 generates the top edge detection signal elapses, the microprocessor 119 cuts the power applied to the feeding motor 111 to stop the feeding roller 106 and the discharge roller 131 (operation S3). The microprocessor 119 then controls the CIS 116 of the sensing part 115 through the image process part 118 to scan and sense the area around the right edge 161 or 161′ of the printing medium P (operation S4).

The image process part 118 extracts a portion identical with a preset grayscale from the image data of the area around the right edge 161 or 161′ sensed by the CIS 116 to detect the image data of the right edge 161 or 161′ of the printing medium P (operation S5). Although the embodiments of the present general inventive concept are described with reference to detection of the right edge 161 or 161′ by the CIS 116 disposed at a right side of the base frame 112, it should be understood that a left edge 171 or 171′ may also be detected with respect to the reference position 150. In this case, the CIS 116 would be disposed on a left side of the base frame 112.

Then, the microprocessor 119 compares the coordinate value of the image data of the right edge 161 or 161′ of the printing medium P detected by the image process part 118 with the coordinate value of the reference position 150 stored in the memory 126 (operation S6). The coordinate value of the image data of the right edge 161 or 161′ may include an average value of X axis coordinate values along the right edge 161 or 161′ of the printing medium P, and the coordinate value of the reference position 150 may include the X axis coordinate value of a right edge of the reference position 150.

As a result of the operation S6, if it is determined that the average value of the X axis coordinate values of the image data of the right edge 161 or 161′ of the printing medium P is equal to the X axis coordinate value of the reference position 150 stored in the memory 126, the microprocessor 119 selects (determines) the unit nozzles 123a of the first row through the nth row to be used for printing as illustrated in FIG. 6A, and performs the operations of feeding the printing medium P to the printing zone PZ (operation S9) and printing image data on the printing medium P using the nozzles 123a in the array type print head 121 of the printing unit 120 (operation 10).

As a result of the operation S6, if it is determined that the average value of the X axis coordinate values of the image data of the right edge 161 or 161′ of the printing medium P is not equal to the X axis coordinate value of the reference position 150 stored in the memory 126, the microprocessor 119 calculates the deviation distance D by which the right edge 161 or 161′ of the printing medium P deviates from the reference position 150 as illustrated in FIG. 6B (operation S7).

Then, the microprocessor 119 determines the unit nozzles 123 to be used for printing by shifting a selection of the unit nozzles 123 by the calculated deviation distance D in one direction. That is, the unit nozzles 123 of the second row through the (n+1) th row as described with reference to FIG. 6B may be selected as the unit nozzles 123 for printing when the microprocessor 119 determines that the calculated deviation distance D corresponds to one row of the unit nozzles 123 (operation S8). Selection of the unit nozzles 123 may be performed similarly for other deviation distances D (i.e., deviation distances corresponding to more than one row of the unit nozzles 123).

As the unit nozzles 123 for printing are determined as described above, the microprocessor 119 reapplies the power to the feeding motor 111. As a result, the feeding roller 106 feeds the printing medium P to the printing zone PZ under the array type print head 121 (the operation S9). At this time, if a distance between the sensing zone SZ and the printing zone PZ is too short so that the printing medium P can not obtain sufficient acceleration for printing, the microprocessor 119 can rotate the feeding motor 111 in reverse to move the printing medium P backward by a certain distance through the feeding roller 106, and then feed the printing medium P to the printing zone PZ such that sufficient acceleration may be obtained.

Then, when the preset third time T3 that it takes the top edge 151 or 151′ of the printing medium P to completely enter the printing zone PZ from a time when the feeding motor 105 is driven elapses, the microprocessor 119 controls the heater chip of the array type print head 121 through the ink exhaust control part 125 so that the plurality of unit nozzles 123 eject the ink onto the printing area PR or PR′ of the printing medium P. Accordingly, the printing medium P is printed with top, left and right print margins T, L, R or T′, L′, R′ (the operation 10) depending on the general printing mode or the borderless printing mode.

When the bottom edge 181 or 181′ of the printing medium P passes through the sensor actuator 109 and the photo sensor 108 generates an OFF signal (i.e., the bottom edge detection signal, the microprocessor 119 controls the heater chip of the array type print head 121 through the ink exhaust control part 125 so that a bottom portion of the printing area PR or PR′ on the printing medium P is printed with left, right and bottom print margins L, R, B or L′, R′, B′ (the operation S10).

As described above, the printing medium P on which an image is printed is discharged out of the image forming apparatus by the discharge roller 131 and the star wheel 131a.

The present general inventive concept can be embodied as computer readable code on a computer readable recording medium. The computer readable recording medium may be any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the internet). The computer readable recording medium can also be distributed over network coupled computer systems so that the computer readable code is stored and executed in a distributed fashion. For example, the nozzle adjustment part 117 may be implemented in software.

An apparatus to automatically adjust nozzle-use, an image forming apparatus and a method of automatically adjusting nozzle-use according to the various embodiments of the present general inventive concept automatically adjust unit nozzles of a print head to be used for printing within a certain range by using a sensing part and a nozzle adjustment part so that image information can be accurately printed on a printing area of a printing medium although the printing medium is not accurately set on a reference position by a medium adjustment guide or although the printing medium P′ is shifted from the reference position by a pick up roller or a feeding roller when picked up or fed. Accordingly, a printing quality can increase and a consumption of the printing medium and ink based on additional printing can decrease. Additionally, an ink contaminant can be prevented when using a borderless printing mode, which occurs when the ink is ejected on a base frame beside left or right printing margins by as much as a deviation distance in which the printing medium is displaced or shifted.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to automatically adjust nozzles used in an image forming device having a print head including a plurality of unit nozzles, the apparatus comprising:
a sensing part disposed at an inlet side of a print head and to sense an area around at least one edge of a printing medium; and
a nozzle use adjustment part to adjust unit nozzles for printing according to a position of the at least one edge of the printing medium detected from a data of the area around the at least one edge sensed by the sensing part.

2. The apparatus as claimed in claim 1, wherein the sensing part is disposed perpendicularly to the at least one edge of the printing medium and comprises one of:
at least one contact image sensor and at least one charge coupled device sensor.

3. The apparatus as claimed in claim 1, wherein the nozzle use adjustment part comprises:
an image process part to extract a portion identical with a fiducial grayscale from the data of the area around the at least one edge sensed by the sensing part to detect a data of the at least one edge of the printing medium, and to calculate a deviation distance by which the at least one edge of the printing medium deviates from a preset reference position from the data of the at least one edge ; and
a microprocessor to determine the unit nozzles to be used for printing from among the plurality of unit nozzles in the print head according to the deviation distance and to control the determined unit nozzles to eject an ink onto a printing area of the printing medium with a certain printing margin.

4. The apparatus as claimed in claim 1, wherein the print head comprises an array type print head in which the plurality of unit nozzles are aligned in a widthwise direction of the printing medium opposite to the printing medium and are arranged in a plurality of lines and rows at regular intervals.

5. The apparatus as claimed in claim 3, wherein the at least one edge of the printing medium is an edge of the printing medium that is parallel with a medium feeding direction, and the certain printing margin includes a printing margin for the edge of the printing medium.

6. A nozzle-use adjustment device usable in an image forming apparatus having a print head with a plurality of nozzles extending along a length that is greater than a width of a printing medium, the device comprising:
a sensing unit to sense a lateral position of a predetermined portion of the printing medium with respect to a lateral reference position; and
a nozzle adjustment part to select a group of adjacent nozzles to print from among the plurality of nozzles in the print head according to the lateral position of the predetermined portion of the printing medium with respect to the lateral reference position.

7. The nozzle-use adjustment device as claimed in claim 6, wherein the nozzle adjustment part selects the group of adjacent nozzles positioned above the printing medium for performing a printing operation.

8. The nozzle-use adjustment device as claimed in claim 6, wherein the plurality of nozzles in the print head comprises:
a first plurality of adjacent nozzles that correspond to the width of the printing medium when the printing medium is in the lateral reference position; and
a second plurality of adjacent nozzles adjacent to the first plurality of nozzles that are operable to perform a printing operation when the sensing unit determines that the printing medium is not in the lateral reference position and is shifted under one or more of the second plurality of adjacent nozzles.

9. A nozzle-use adjustment device usable in an image forming apparatus having a print head, the device comprising:
a sensing part to determine information about a lateral location of a printing medium; and
a nozzle adjustment part to select nozzles in the print head that correspond to the information about the lateral location of the printing medium.

10. The nozzle adjustment device as claimed in claim 9, wherein the sensing part senses the lateral location of the printing medium with respect to a reference point on a printing zone on a base frame in the image forming apparatus.

11. The nozzle adjustment device as claimed in claim 9, wherein the nozzle adjustment part is operable to select nozzles in the print head for a plurality of different sizes of printing mediums.

12. The nozzle adjustment device as claimed in claim 11, wherein the print head comprises a plurality of nozzles arranged in rows, and each of the plurality of different sizes corresponds to a predetermined number of rows of nozzles in the print head.

13. The nozzle adjustment device as claimed in claim 9, wherein the print head comprises a plurality of nozzles arranged in rows and a size of the printing medium corresponds to a predetermined number of rows of the nozzles such that the nozzle adjustment part shifts the selected nozzles by a number of rows that corresponds to a lateral distance that the printing medium deviates from a reference position.

14. The nozzle adjustment device as claimed in claim 9, wherein the sensing part senses the lateral location of the printing medium with respect to a reference position, and the print head comprises a plurality of nozzles arranged in a line along a lateral direction such that the nozzle adjustment part selects a group of nozzles to print to the printing medium when the printing medium is determined to be in the reference position and shifts the selected group nozzles along the line by a number of nozzles that corresponds to a lateral distance that the printing medium deviates from the reference position.

15. The nozzle adjustment device as claimed in claim 9, wherein the sensing part is disposed to one side of the printing medium and comprises:
a sensor to detect image information about an edge of the printing medium by emitting light thereto and sensing light reflected therefrom, and the nozzle adjustment device further comprises:
an image process part to compare the sensed reflected light with predetermined image information to determine a position of the edge of the printing medium.

16. The nozzle adjustment device as claimed in claim 15, wherein the sensor is disposed over the edge of the printing medium and extends over a range of possible deviation of the edge from the reference position.

17. A nozzle-use adjustment device usable in an image forming apparatus including a print head having a plurality of nozzles extending at least as wide as a printing medium, the device comprising:
a sensing part to sense a lateral position of the printing medium in a printing zone; and
a nozzle adjustment part to select a first group of the plurality of nozzles to perform a first printing operation when the sensing part senses that the printing medium is in a first lateral position and to select a second group of the plurality of nozzles to perform a second printing operation when the sensing part senses that the printing medium is in a second lateral position.

18. An image forming apparatus, comprising:
a feeding part to feed a printing medium;
an array type print head in which a plurality of unit nozzles are aligned in a widthwise direction of the printing medium opposite to the printing medium and arranged in a plurality of lines and rows at regular intervals;
a sensing part disposed at an inlet side of the array type print head to sense an area around at least one edge of the printing medium fed by the feeding part; and
a nozzle use adjustment part to adjust unit nozzles for printing according to a position of the at least one edge of the printing medium detected from a data of the area around the at least one edge sensed by the sensing part.

19. The apparatus as claimed in claim 18, wherein the sensing part is disposed perpendicularly to the at least one edge of the printing medium and comprises one of:
at least one contact image sensor and at least one charge coupled device sensor.

20. The image forming apparatus as claimed in claim 18, wherein the nozzle use adjustment part comprises:
an image process part to extract a portion identical with a fiducial grayscale from the data of the area around the at least one edge sensed by the sensing part to detect the data of the at least one edge of the printing medium, and to calculate a deviation distance by which the at least one edge of the printing medium deviates from a preset reference position from the data of the at least one edge detected thereby; and
a microprocessor to determine unit nozzles for printing from among the plurality of unit nozzles in the array type print head according to the calculated deviation distance and to control the determined unit nozzles to eject an ink onto a printing area of the printing medium with a certain printing margin.

21. The apparatus as claimed in claim 20, wherein the at least one edge of the printing medium is an edge of the printing medium that is parallel with a medium feeding direction, and the certain printing margin includes a printing margin for the edge of the printing medium.

22. An image forming apparatus, comprising:
a print head having a plurality of nozzles extending in a line along at least a width of a printing medium;
a sensing part to determine information about a location of the printing medium; and
a nozzle adjustment part to select adjacent nozzles in the line in the print head that correspond to the information about the location of the printing medium.

23. The image forming apparatus as claimed in claim 22, wherein the plurality of nozzles comprise reference position nozzles to be used for printing when the printing medium is determined to be in a reference position and extra nozzles disposed adjacent to the reference position nozzles to be used for printing when the printing medium is determined not to be in the reference position.

24. The image forming apparatus as claimed in claim 23, wherein the extra nozzles are disposed on one side of the reference position nozzles in the line.

25. The image forming apparatus as claimed in claim 23, wherein the extra nozzles are disposed on both sides of the reference position nozzles in the line.

26. The image forming apparatus as claimed in claim 22, further comprising:
a base frame having a printing zone onto which the printing medium is transferred to be printed on, wherein the sensing part determines the location of the printing medium with respect to a reference position on the base frame along a lateral direction of the printing medium.

27. The image forming apparatus as claimed in claim 26, wherein the sensing part determines the location of the printing medium with respect to the reference position by determining a coordinate value of a side edge of the printing medium and comparing the determined coordinate value to a predetermined coordinate value of the reference position.

28. The image forming apparatus as claimed in claim 26, wherein the nozzle adjustment part comprises a control processor to control operation thereof according to the sensing part and to control operation of the print head according to the determined location of the printing medium.

29. The image forming apparatus as claimed in claim 28, further comprising:
a medium detection part to detect information about a longitudinal position of the printing medium along a transferring direction thereof and to provide the detected information about the longitudinal position of the printing medium to the control processor such that the control processor controls the nozzle adjustment part, accordingly.

30. The image forming apparatus as claimed in claim 22, wherein the nozzle adjustment part is operable between a first print mode to print to the printing medium with a normal margin within the printing medium and a second print mode to print the printing medium without a margin in the printing medium.

31. The image forming apparatus as claimed in claim 22, further comprising:
an ink exhaust control part to drive an ink ejecting mechanism in the print head according to one or more nozzle group selection signals received from the nozzle adjustment part.

32. The image forming apparatus as claimed in claim 22, wherein the nozzle adjustment part drives the print head to eject ink from the selected nozzles such that ink is ejected within a predetermined print area on the printing medium.

33. An image forming apparatus, comprising:
a print head disposed in a fixed position and including a plurality of nozzles arranged in a line extending at least a width of a printing medium;
a frame disposed under the print head to receive the printing medium to a printing position for printing; and
a nozzle adjustment unit to determine a position of the printing medium and to control the nozzles in the print head to print to the printing medium with a proper margin, regardless of whether the position of the printing medium is the printing position.

34. The image forming apparatus as claimed in claim 33, wherein the nozzle adjustment unit controls the print head to print in one of a borderless mode and a margin mode.

35. The image forming apparatus as claimed in claim 33, wherein the plurality of nozzles include extra nozzles such that the nozzle adjustment unit selects one or more of the extra nozzles to print to the printing medium when the position of the printing medium is determined not to be the printing position without moving the print head.

36. A method of automatically adjusting nozzles used in an image forming apparatus, the method comprising:
detecting a position of at least one edge of a printing medium;
determining unit nozzles of a print head to be used for printing according to the detected position of the at least one edge of the printing medium; and
controlling the determined unit nozzles to eject an ink onto a printing area of the printing medium.

37. The method as claimed in claim 36, wherein the detecting of the position of the at least one edge of the printing medium comprises:
sensing an area around the at least one edge of the printing medium;
extracting a portion identical with a fiducial grayscale from a data of the sensed area around the at least one edge of the printing medium to detect a data of the at least one edge of the printing medium; and
calculating a coordinate value of the at least one edge of the printing medium from the detected data of the at least one edge of the printing medium.

38. The method as claimed in claim 37, wherein the determining of the unit nozzles of the print head to be used for printing comprises:
comparing the calculated coordinate value of the at least one edge of the printing medium with a preset coordinate value of a reference data to calculate a deviation distance by which the at least one edge of the printing medium deviates from a preset reference position; and
determining the unit nozzles to be used for printing as shifting by as much as the calculated deviation distance.

39. The method as claimed in claim 38, wherein the controlling of the determined unit nozzles to eject the ink comprises:
ejecting the ink onto the printing area of the printing medium having a certain printing margin by using the unit nozzles determined as the unit nozzles to be used for printing.

40. The method as claimed in claim 39, wherein the at least one edge of the printing medium is an edge of the printing medium that is parallel with the medium feeding direction, and the certain printing margin includes a printing margin for the edge of the printing medium.

41. A method of controlling an image forming apparatus including a print head having a plurality of nozzles extending along at least a width of a printing medium, the method comprising:
sensing information about a lateral location of the printing medium; and
selecting nozzles from among the plurality of nozzles in the print head that correspond to the information about the lateral location of the printing medium.
